(19) United States
(12) Patent Application Publication
(10) Pub. No.: US 2009/0102817 A1
(43) Pub. Date: Apr. 23, 2009

(54) USER INPUT DEVICE WITH FLYWHEEL FOR SCROLLING

(75) Inventors: Steven Bathiche, Kirkland, WA (US); William Buxton, (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/873,431

(22) Filed: Oct. 17, 2007

(51) Int. Cl. G06F 3/033

(52) U.S. Cl. 345/184

(57) ABSTRACT

User input devices and methods for use in scrolling with a computing device are provided. One disclosed user input device includes a housing, a control surface coupled to the housing and configured to be manipulated by a digit of the user, and a flywheel operatively coupled to the control surface, such that motion of the digit of the user on the control surface is transferred to the flywheel. The flywheel may be a mechanical flywheel operated by a scroll wheel on which the control surface is positioned, or a virtual flywheel implemented by a computer program and operated by a pressure sensitive input device on which the control surface is positioned.

### BACKGROUND

Many computer programs provide users the ability to scroll through documents using user input devices such as a mouse with a scroll wheel, or a trackpad. The scroll resolution, which affects the distance that can be scrolled in a single actuation, or “clutch,” may be set to an accuracy level, for example, so that the user may scroll to a particular line or pixel on the screen, as desired. However, setting the scroll resolution to such an accuracy level has an inverse effect on the distance that a user can scroll in a single clutch, i.e., the higher the scroll resolution, the shorter the distance that can be scrolled in a single clutch.

Thus, to scroll through a long document at a typical scroll resolution, the user must repeatedly clutch the user input device. Such repeated clutching is time consuming and may cause the user's fingers to grow tired, potentially reducing productivity and increasing frustration of the user.

In addition, in laptop computing devices with trackpads, many computer programs render the trackpad useless when an external mouse is plugged into an input port. Many users attempt to actuate the de-activated trackpad, causing unneeded clutching and increasing the user's frustration.

### SUMMARY

User input devices and user input methods for use in scrolling with a computing devices are provided. One disclosed user input device may include a housing, a control surface coupled to the housing and configured to be manipulated by a digit of the user, and a flywheel operatively coupled to the control surface, such that motion of the digit of the user on the control surface is transferred to the flywheel. The flywheel may be a mechanical flywheel operated by a scroll wheel on which the control surface is positioned, or a virtual flywheel implemented by a computer program and operated by a pressure sensitive input device on which the control surface is positioned. Flywheel output is sent to a scroll event detector, which in turn sends a notification to an application program when a scroll event occurs. The application program renders the scroll event accordingly, in a graphical user interface associated with the application program.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a partial cutaway perspective view of one embodiment of a computer system including user input devices for use in scrolling.

FIG. 2 is a schematic view of the computer system of FIG. 1.

FIG. 3 is a flowchart illustrating one embodiment of a user input method for use in scrolling.

FIG. 4 is a flowchart illustrating additional steps in the method of FIG. 3.

FIG. 5 is one embodiment of a method for detecting scroll events of the method of FIG. 3, and transitioning between scroll states.

FIG. 5 is another embodiment of a method for detecting scroll events of the method of FIG. 3, and transitioning between scroll states.

### DETAILED DESCRIPTION

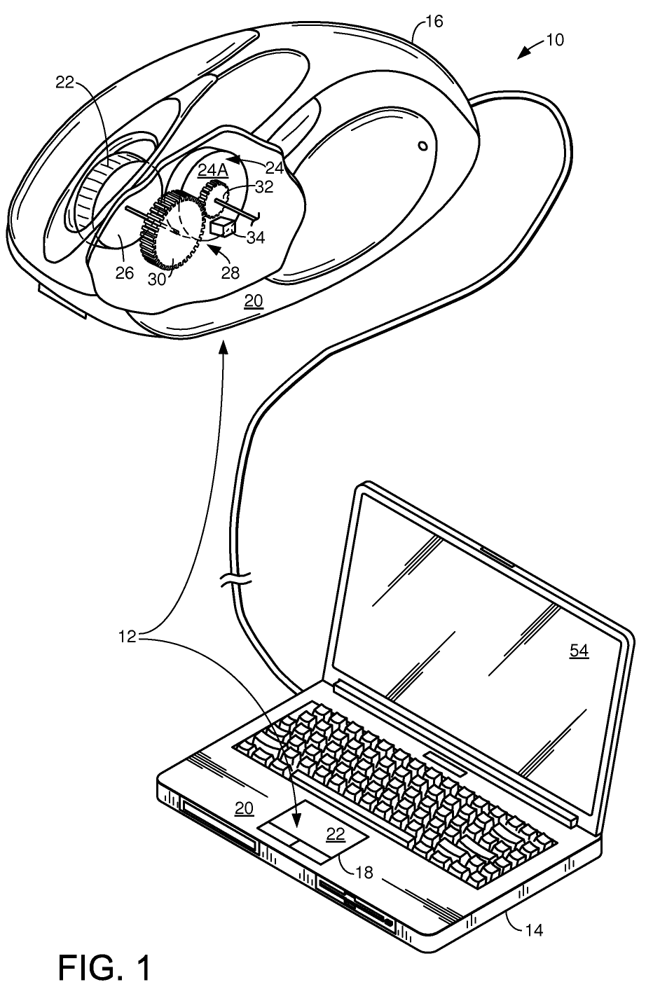

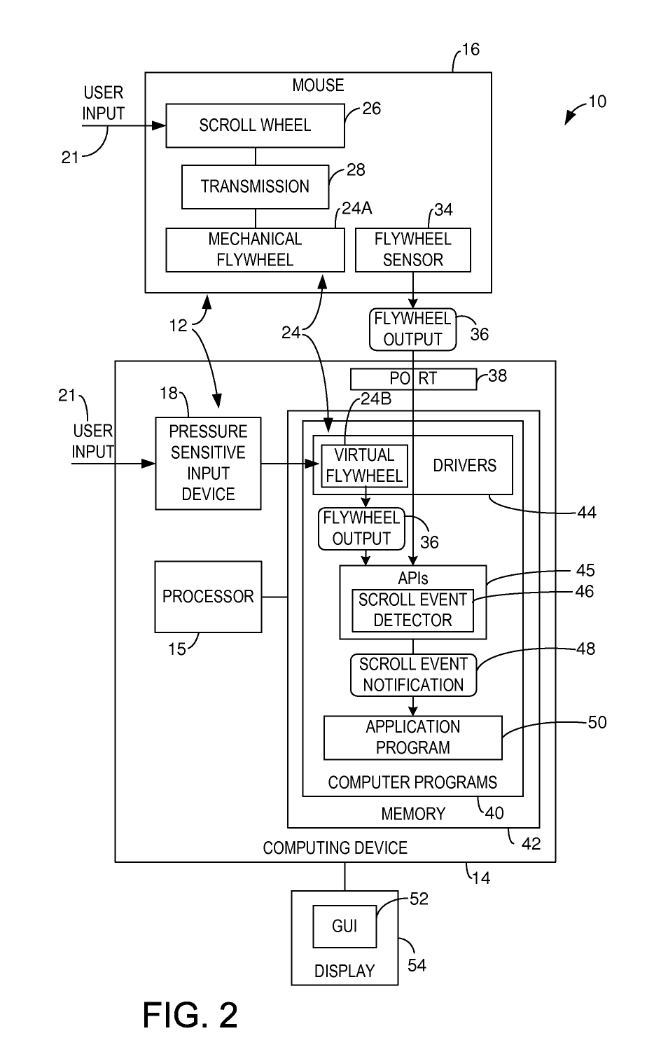

FIGS. 1 and 2 illustrate a computer system 10 including one or more user input devices 12 and an associated computing device 14. User input device 12 may take the form of a mouse 16 and/or pressure sensitive input device 18. In the illustrated embodiment, the pressure sensitive input device 18 is a trackpad; however, it will be appreciated that the pressure sensitive input device 18 may alternatively be a touch sensitive screen, etc.

As shown in FIG. 2, computing device 14 may be virtually any computing device having a processor 15 and associated memory 40 configured to store various computer programs 42 that are executed by the processor 15, as described below. In the depicted embodiment, computing device 14 is a laptop computer with a pressure sensitive input device 18 in the form of a trackpad. Alternatively, a computing device without a pressure sensitive input device 18 may be utilized.

Each of the user input devices 12 typically includes a housing 20, a control surface 22 coupled to the housing 20 and configured receive user input 21 through manipulation by a digit of the user. User input device 12 further includes a flywheel 24 operatively coupled to the control surface 22, such that motion of the digit of the user on the control surface 22 is transferred to the flywheel 24.

In mouse 16, the control surface 22 is formed on a scroll wheel 26 coupled to the housing 20, and the flywheel 24 is a mechanical flywheel 24A mounted in the housing. The user input device 12 may further include a transmission 28 operatively coupling the mechanical flywheel 24A to the scroll wheel 26. The transmission 28 may include a scroll wheel gear 30 intermeshed with a flywheel gear 32. Various other gears may be included in transmission 28 to achieve a desired gear ratio.

Mechanical flywheel 24A is configured to rotate in either direction under the inertia of its own mass, upon being imparted with rotational motion from the scroll wheel 26 via the transmission 28. The mechanical flywheel 24A stores kinetic energy from the scroll wheel 26 and distributes it over time through its own rotation, which is in turn transferred back to the scroll wheel 26 when the user's digit is released. To start scrolling, the user clutches the scroll wheel 26, for example, once or twice, and the kinetic energy imparted to the mechanical flywheel 24A causes the scroll wheel 26 to start rotating and continue rotating even after the user's digit has been removed from the scroll wheel 26. To brake or stop scrolling, the digit of the user may be used as a mechanical brake against the control surface 22 of the scroll wheel 26 to absorb the stored energy in the mechanical flywheel 24A, and slow the scrolling down in order to stop scrolling at a target location in a document.

A flywheel sensor 34 may be mounted in the housing and configured to sense the rotation of the mechanical flywheel 24A. As shown in FIG. 2, the sensor is configured to produce a flywheel output 36, which is a signal or event indicating the movement of the flywheel. The flywheel output 36 may indicate, for example, the direction of rotation of the mechanical flywheel 24A, which indirectly indicates the direction of rotation of the scroll wheel 26, and also the speed of rotation of the mechanical flywheel 24A. The flywheel output 36 is sent to the computing device 14 via a user input device port 38, and may be interpreted by computer programs 40 on the computing device 14 to implement inertial scrolling.

The size and weight of the mechanical flywheel 24A, scroll wheel 26, and transmission 28 may be designed for a desired performance, based on a variety of factors. For example, for a desired average browsing speed (Vb) in the range from 1-10 lines per second, the resolution of the scroll wheel may be calculated in scroll counts per revolution (Sr=counts/revolution). The speed of the scroll wheel Vs may be represented as Vs=Vb/Sr.

Knowing that Vs=Vb/Sr, equations for velocity and force may be applied to calculate the mass of the flywheel. Since velocity is acceleration multiplied by time (Vs=A*T), the acceleration of the scroll wheel may be calculated for a desired response time, such as a few seconds. To calculate the mass of the flywheel, an equation relating mass to force divided by acceleration (M=F/A) may be applied. The desired force may be derived, for example, from user interaction studies over a population of users, which indicate an average comfortable force for scroll wheel usage. Knowing the desired force, the mechanical flywheel 24A may be designed with the appropriate mass, and made to feel heavier or lighter through the use of higher or lower gear reduction ratios in transmission 28.

While the depicted embodiment utilizes a flywheel sensor 34 configured to sense motion of the mechanical flywheel 24A, it will be appreciated that a sensor may be provided to sense the motion of the scroll wheel 26 and/or transmission 28, in addition to or as an alternative to the flywheel sensor 34, since the motion of the mechanical flywheel 24A, transmission 28, and scroll wheel 26 are linked.

Alternatively or in addition to the mouse 16 with the mechanical flywheel 24A, a control surface 22 may be formed on the pressure sensitive input device 18 and coupled to a housing 20 of the pressure sensitive input device 18. Correspondingly, as shown in FIG. 2, the flywheel 24 may be a virtual flywheel 24B modeled in a computer program 40 stored in memory 42 and executed on the computing device 14. The virtual flywheel 24B may be implemented, for example, in a driver program 44 for the pressure sensitive input device 18, or in other appropriate software on the computing device 14. The virtual flywheel 24B is configured to send a flywheel output 36 indicating the movement of the virtual flywheel 24B to a computer program 40 for downstream application.

The virtual flywheel 24B is configured to model the physical behavior of the mechanical flywheel 24A described above, with differences in the manner in which motion is imparted to the control surface and the manner in which braking and stopping are achieved. Scrolling may be initiated by detecting that a user has swiped the pressure sensitive input device 18 in a determined direction, and the amount of rotational energy imparted to the virtual flywheel 24B is determined by the pressure of the user's digit on the pressure sensitive input device 18. Thus, swiping in a downward direction while pressing down hard on the trackpad will result in a downward scroll at a high scroll speed and high kinetic energy imparted to the virtual flywheel 24B. Braking is accomplished by the user releasing pressure on the pressure sensitive input device 18, and stopping is accomplished when the user's digit is released from the pressure sensitive input device 18. The logic to implement this functionality is contained within computer programs 40, such as drivers 44 and application programming interface (API) 45, as discussed below.

The flywheel output 36 from either or both of the mouse 16 and the pressure sensitive input device 18 is typically received by a computer program 40 such as an API 45, which includes a scroll event detector 46 configured to process the flywheel output 36. The scroll event detector 46 is configured to detect a scroll event based on the flywheel output 36, and further is configured to send a scroll event notification 48 to an application program 50, the scroll event notification instructing the application program to start scrolling in the determined direction, brake scrolling, or stop scrolling, in a pane of a graphical user interface 52 of the application program, displayed on a display 54 associated with the computing device 14.

Thus, the scroll event may be one of a start scroll event, a brake scroll event, and a stop scroll event. The start scroll event is determined to have occurred upon detecting flywheel movement in a determined direction over a predetermined time interval. For the mouse 16, the motion of the mechanical flywheel 24A is sensed through flywheel sensor 24. A start scroll event may be detected when the motion of the mechanical flywheel 24A exceeds a predetermined threshold in a determined direction, or alternatively, when any rotational motion of the mechanical flywheel 24A is detected.

A brake scroll event may be detected when the rotational motion of the mechanical flywheel 24A is detected as slowing down. And a stop scroll event may be detected when the motion of the mechanical flywheel 24A is detected to have dropped below a predetermined threshold, or alternatively, has stopped.

For the pressure sensitive input device 18, the start scroll event may be determined to have occurred by detecting swiping of a digit of the user in a determined direction on the pressure sensitive input device 18, and additionally the pressure of the user's digit during swiping on the pressure sensitive input device 18 may also be detected and used to determine the momentum imparted to the virtual flywheel 24B. The scroll event detector 46 may be configured such that once movement in the predetermined direction on the pressure sensitive input device 18 is detected, subsequent detection of movement up or down produces commands to scroll in the same direction, rather than in different directions. Further, the scroll event detector 46 may be configured such that direction of scroll is reset upon detecting that the user lifts a digit off of the pressure sensitive user input device or movement is detected to stop moving for a predetermined interval of time. The brake scroll event may be determined to have occurred upon detecting an increase in pressure in the digit of the user on the pressure sensitive input device 18, and the stop scroll event may be determined to have occurred upon detecting removal of the digit of the user from the pressure sensitive input device 18. It will be appreciated that in some embodiments, the brake scroll event may be omitted, as described below in relation to FIG. 6.

In this manner, the user may use the above described user input devices 12 with mechanical flywheel 24A and virtual flywheel 24B to inertially scroll through a document, either by swiping a digit on pressure sensitive input device 18 or by actuating the scroll wheel 26 of mouse 16, which user input 21 will interpreted to control starting, braking, and stopping of scrolling.

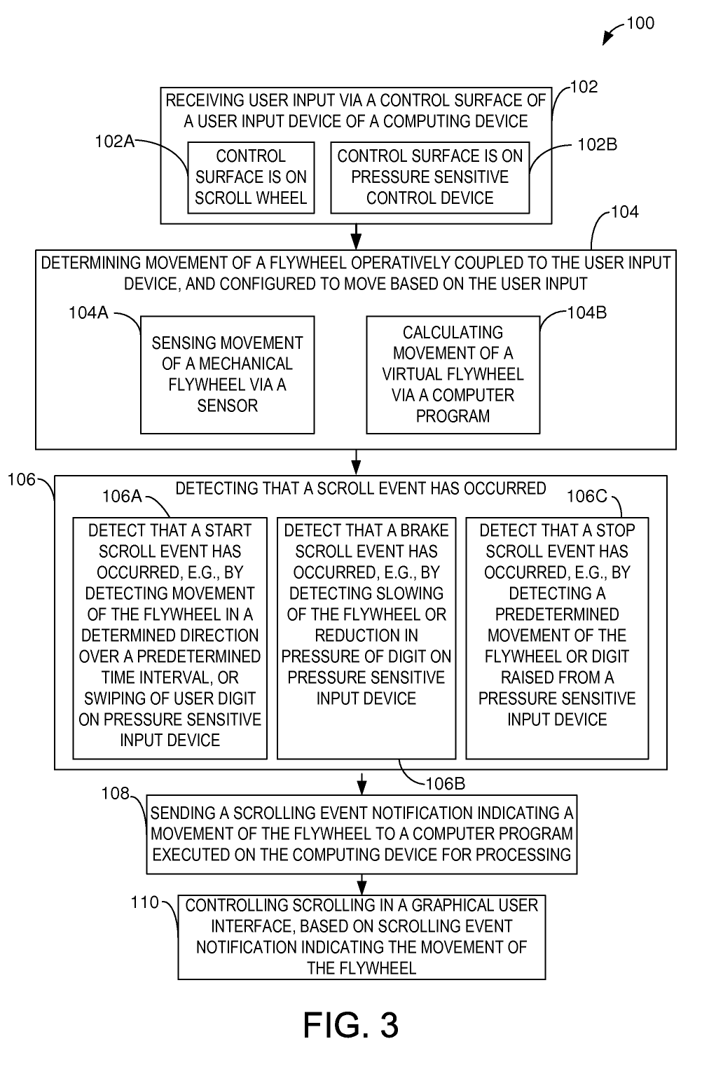

FIG. 3 illustrates a user input method 100 that may be implemented using the above described computer system with user input devices, or using other suitable systems and devices. Method 100 includes, at 102, receiving user input via a control surface of a user input device of a computing device. At 104, the method may include determining movement of a flywheel operatively coupled to the user input device and configured to move based on the user input.

At 106, the method may include detecting that a scroll event has occurred based on the movement of the flywheel. At 108, the method may include sending a scroll event notification to a computer program indicating the movement of the flywheel according to the scroll event. At 110, the method may include controlling scrolling in a graphical user interface, based on the scroll event notification indicating the movement of the flywheel.

As illustrated at 102A, the control surface may be on a scroll wheel of the user input device. Accordingly, the flywheel may be a mechanical flywheel mounted in a housing of the user input device and may be operatively coupled to the scroll wheel, such that movement of the control surface induces movement in the flywheel, as described above. As illustrated at 104A, determining movement of the flywheel may include sensing movement of the flywheel via a sensor mounted in the housing. The sensor may be a flywheel sensor configured to directly detect motion of the flywheel, or a sensor placed at another suitable location on components with corresponding movement to the flywheel, such as a scroll wheel or transmission. The flywheel output from the mechanical flywheel may be used to detect a scroll event. For example, detecting a scroll event at 106 may include detecting movement of the mechanical flywheel in a determined direction over a predetermined time interval.

As illustrated at 102B, the control surface may be formed on a pressure sensitive input device of the computing device. Accordingly, the flywheel may be a virtual flywheel modeled in computer software executed on the computing device, as described above. As illustrated at 104B, determining movement of the flywheel may include calculating the movement of the virtual flywheel via a computer program executable on the computing device, based on the signal from the user input device. The flywheel output from the virtual flywheel may be used to detect a scroll event. For example, detecting a scroll event at 106 may include detecting movement on the pressure sensitive input device in a determined direction over a predetermined time interval, and also pressure of a user's digit on the pressure sensitive user input device.

As illustrated at 106A-106C, detecting that a scroll event has occurred at 106 may include detecting a scroll event from among a defined set of scroll events, including a start scroll event, a brake scroll event, and a stop scroll event, as described above. For example, as shown at 106A, a start scroll event may be detected by detecting movement of the flywheel in a determined direction over a predetermined time interval. Alternatively, also at 106A, detecting a scroll event may include detecting swiping of a digit on a pressure sensitive input device in a determined direction over a predetermined time interval.

As illustrated at 106B, detecting a scroll event at 106 may further include detecting that a brake scroll event has occurred, for example, by detecting a slowing of a mechanical flywheel or virtual flywheel, or by detecting a reduction in pressure of a digit on a pressure sensitive input device.

As illustrated at 106C, detecting a scroll event at 106 may further include detecting that a stop scroll event has occurred, for example, by detecting a predetermined movement of the mechanical flywheel or virtual flywheel, such as a slowing below a threshold speed, or a stopping of the flywheel, or by detecting that a user's digit has been raised off of a pressure sensitive input device.

It will be appreciated that the start scroll event, brake scroll event, and stop scroll event are merely illustrative and that various other scroll events may be defined, and that various other factors, inputs, and calculations may be used to determine these events have occurred, as appropriate.

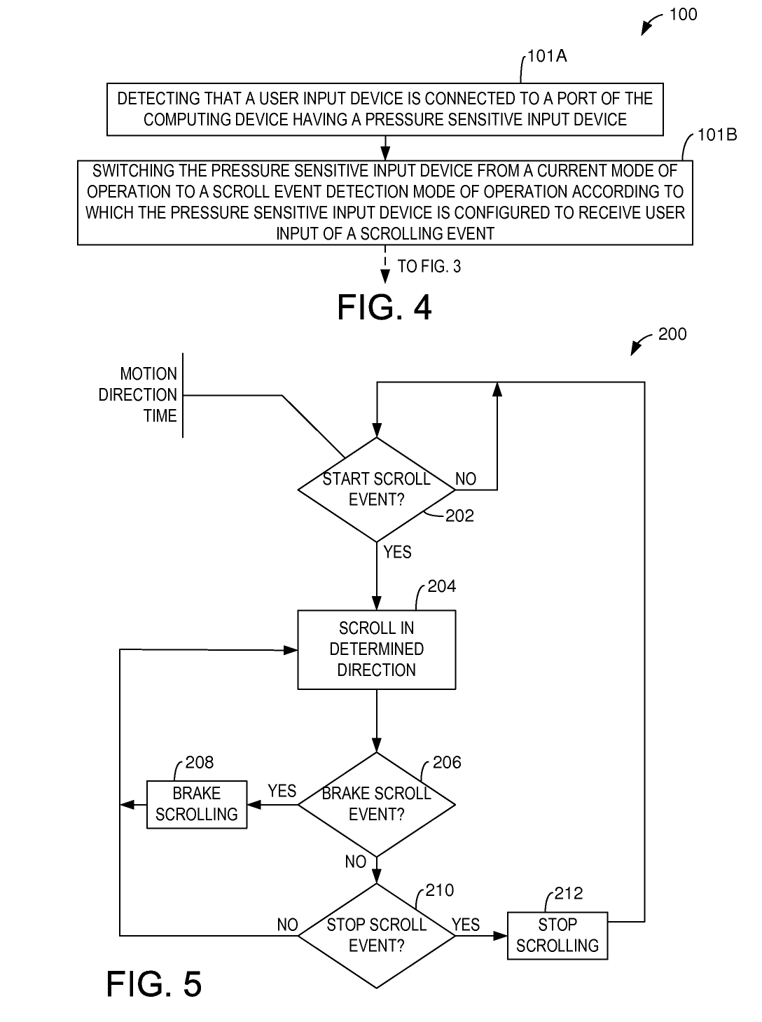

As illustrated in FIG. 4, the method 100 may further include, prior to receiving user input at 102, detecting that a user input device is connected to a port of a computing device having a pressure sensitive input device, as illustrated at 101A, and upon said detecting, switching the pressure sensitive input device from a current mode of operation to a scroll event detection mode of operation according to which the pressure sensitive input device is configured to receive user input of a scroll event, as illustrated at 101B. It will be appreciated that the scroll event may be one of a start scroll event, a brake scroll event, and a stop scroll event, and may be detected based on a flywheel output of a virtual flywheel, as described above.

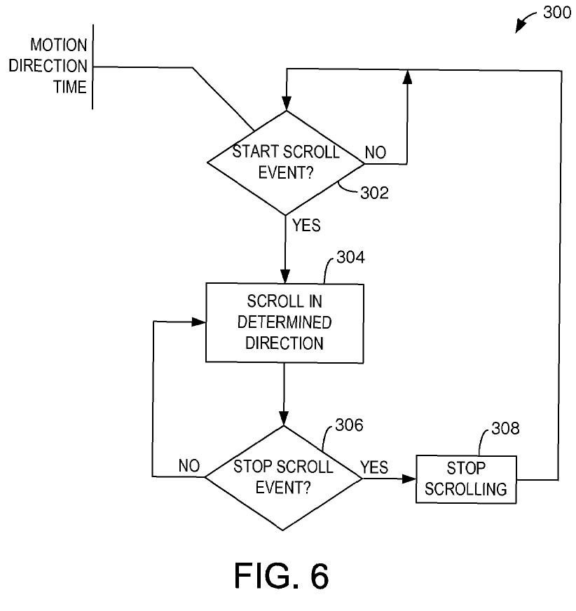

FIG. 5 illustrates a state transition diagram for a method 200 for detecting start scroll events, brake scroll events, and stop scroll events, and transitioning between a scrolling state, a braking state, and a stopped scrolling state. At 202, the method includes determining whether a start scroll event has occurred, based on a flywheel output indicating a motion, direction, and time of user input on a control surface of a user input device. As described above, a start scroll event may be determined to have occurred upon detecting movement of the user input device in a determined direction over a predetermined time interval, and, for a pressure sensitive user input device, may also involve detecting a pressure of a digit on the control surface. If no start scroll event is detected, the method loops back to continue detecting a start scroll event at 202. Upon detecting the start scroll event at 202, the method proceeds to 204, and a GUI of an application program is instructed to scroll in the determined direction, at a scroll rate that is preset, or calculated based on a factor such as the pressure of the digit on a pressure sensitive input device, detected rotational speed of the flywheel, etc.

At 206, the method determines whether a brake scroll event has occurred. This may be determined, for example, by detecting a reduction in rotation speed of the flywheel, or by detecting a reduction in the pressure of a user digit on a control surface of a pressure sensitive input device, etc. If no brake scroll event is detected, then the method proceeds to step 210. Upon detecting that the brake scroll event has occurred, the method proceeds to brake scrolling at 208, and loops back to 204 to scroll in the determined direction at a slower scroll rate.

At 210, the method determines whether a stop scroll event has occurred. This may be determined, for example, by detecting that the flywheel rotation has dropped below a predetermined rotational speed, that the scroll wheel has been actuated in a predetermined manner, such as clicking or rotating in an opposite direction of the scroll, by detecting that a digit of the user has been raised off a pressure sensitive user input device, etc. If no stop scroll event is detected, the method loops to continue scrolling in the determined direction at 204. Upon detecting the stop scroll event at 210, the method proceeds to 212 and scrolling is stopped. The method further loops back to 202 at which it is determined whether a start scroll event has once again occurred.

FIG. 6 illustrates a second state transition diagram illustrating a method 300 for detecting start scroll events and stop scroll events, and transitioning between a scrolling state and a stopped scrolling state. In this embodiment, the brake scroll event described above may be omitted. This embodiment may be used, for example, in connection with the pressure sensitive input device 18. Method 300 enables a user to swipe a digit on the control surface to begin scrolling, and will continue scrolling until it is detected that the digit has been raised off of the control surface. The scrolling can occur at a scroll rate that is either preset or that is calculated based on a detected pressure of the user digit during the swipe, for example. The scroll rate may be determined as described above.

At 302, the method includes determining whether a start scroll event has occurred, based on a flywheel output indicating a motion, direction, and time of user input on a control surface of a user input device. A start scroll event is determined to have occurred upon detecting movement of the user input device in a determined direction over a predetermined time interval. If no start scroll event is detected, the method loops back to continue detecting a start scroll event at 302. Upon detecting the start scroll event at 302, the method proceeds to 304, and a GUI of an application program is instructed to scroll in the determined direction.

At 306, the method determines whether a stop scroll event has occurred. This may be determined, for example, by detecting that the flywheel rotation has dropped below a predetermined rotational speed, that the scroll wheel has been actuated in a predetermined manner, such as clicking or rotating in an opposite direction of the scroll, or by detecting that a digit of the user has been raised off a pressure sensitive user input device. If no stop scroll event is detected, the method loops to continue scrolling in the determined direction at 304. Upon detecting the stop scroll event at 306, the method proceeds to 308 and scrolling is stopped. The method further loops back to 302 at which it is determined whether a start scroll event has once again occurred.

The systems and method described above may be used to scroll through documents in an efficient manner that potentially reduces the number of times clutching is performed, thereby improving the scrolling experience for the user.

It will be appreciated that the computing devices described herein may be any suitable computing device configured to execute the programs and display the graphical user interfaces described herein. For example, the computing devices may be a personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A user input device for a computing device, the user input device comprising:
a housing;
a control surface coupled to the housing and configured to be manipulated by a digit of the user; and
a flywheel operatively coupled to the control surface, such that motion of the digit of the user on the control surface is transferred to the flywheel.

2. The user input device of claim 1, wherein the control surface is formed on a scroll wheel coupled to the housing.

3. The user input device of claim 2, wherein the flywheel is a mechanical flywheel mounted in the housing.

4. The user input device of claim 3, further comprising a transmission operatively coupling the mechanical flywheel to the scroll wheel.

5. The user input device of claim 4, further comprising a flywheel sensor mounted in the housing and configured to sense a rotation of the flywheel.

6. The user input device of claim 1, wherein the control surface is formed on a pressure sensitive input device coupled to the housing.

7. The user input device of claim 6, wherein the flywheel is a virtual flywheel modeled in a computer program executed on the computing device.

8. The user input device of claim 1, further comprising a scroll event detector configured to detect a scroll event based on a flywheel output, and further configured to send a scroll event notification to an application program, the scroll event notification instructing the application program to start scrolling in a determined direction, or stop scrolling, in a pane of a graphical user interface of the application program.

9. The user input device of claim 8,
wherein the scroll event is one of a start scroll event and a stop scroll event;
wherein the start scroll event is determined to have occurred upon detecting flywheel movement in a determined direction over a predetermined time interval, the flywheel movement being induced by a detected swiping of a digit of the user in the determined direction on a pressure sensitive input device;
wherein the stop scroll event is determined to have occurred upon detecting removal of the digit of the user from the pressure sensitive input device.

10. A user input method for use in scrolling in a computing device, comprising:
receiving user input via a control surface of a user input device of a computing device;
determining movement of a flywheel operatively coupled to the user input device and configured to move based on the user input;
detecting that a scroll event has occurred based on the movement of the flywheel; and
sending a scroll event notification to a computer program indicating the movement of the flywheel in the scroll event.

11. The user input method of claim 10, further comprising:
controlling scrolling in a graphical user interface, based on the scroll event notification indicating the movement of the flywheel.

12. The user input method of claim 10, wherein the control surface is on a scroll wheel of the user input device, and wherein the flywheel is a mechanical flywheel mounted in a housing of the user input device and is operatively coupled to the scroll wheel, such that movement of the control surface induces movement in the flywheel.

13. The user input method of claim 12, wherein determining movement of the flywheel includes sensing movement of the flywheel via a sensor mounted in the housing.

14. The user input method of claim 13, wherein detecting a scroll event includes detecting movement of the flywheel in a determined direction over a predetermined time interval.

15. The user input method of claim 10, wherein the control surface is formed on a pressure sensitive input device of the computing device, and wherein the flywheel is a virtual flywheel modeled in a computer program executed on the computing device.

16. The user input method of claim 15, wherein determining movement of the flywheel includes calculating the movement of the virtual flywheel via a computer program executable on the computing device, based on a signal from the user input device.

17. The user input method of claim 16, wherein detecting a scroll event includes detecting movement on the pressure sensitive input device in a determined direction over a predetermined time interval.

18. The user input method of claim 15, further comprising:
detecting that a user input device is connected to a port of the computing device having a pressure sensitive input device; and
upon said detecting, switching the pressure sensitive input device from a current mode of operation to a scroll event detection mode of operation according to which the pressure sensitive input device is configured to receive user input of a scroll event.

19. The method of claim 18,
wherein the scroll event is one of a start scroll event and a stop scroll event;
wherein the start scroll event is determined to have occurred upon detecting flywheel movement in a determined direction over a predetermined time interval, the flywheel movement being induced by a detected swiping of a digit of the user in the determined direction on a pressure sensitive input device; and
wherein the stop scroll event is determined to have occurred upon detecting removal of the digit of the user from the pressure sensitive input device, or upon detecting that the digit stops moving for a predetermined interval of time.

20. A user input method, comprising:
upon detecting that a user input device is connected to a port of a computing device having a pressure sensitive input device, switching the pressure sensitive input device from a current mode of operation to a scroll event detection mode of operation according to which the pressure sensitive input device is configured to receive user input of a scroll event.
